(19) United States
(12) Patent Application Publication
(10) Pub. No.: US 2022/0010934 A1
(43) Pub. Date: Jan. 13, 2022

(54) SYSTEM AND METHOD FOR EFFICIENT ISOTHERMAL COMPRESSION

(71) Applicant: UNIVERSITY OF MARYLAND, COLLEGE PARK, COLLEGE PARK, MD (US)

(72) Inventors: K. REINHARD RADERMACHER, SILVER SPRING, MD (US); VIKRANT C. AUTE, JESSUP, MD (US); JIAZHEN LING, ELLICOTT CITY, MD (US); YUNHO HWANG, ELLICOTT CITY, MD (US); JAN MUEHLBAUER, FULTON, MD (US)

(21) Appl. No.: 17/305,526

(22) Filed: Jul. 9, 2021

Related U.S. Application Data
(60) Provisional application No. 63/050,407, filed on Jul. 10, 2020.

(51) Int. Cl. F17D 1/12; F17D 1/08

(52) U.S. Cl. CPC F17D 1/12; F17D 1/082

(57) ABSTRACT

The disclosed systems and methods are related to a positive displacement compression for use in various applications including gas processing, air conditioning, refrigeration, etc., to produce an isothermal compression to enhance the compression efficiency. The heat exchange enhanced compression is conducted by the use of cylinders partially filled with incompressible fluid (e.g., oil) acting as a piston compressing working fluid (e.g., CO₂). The isothermal compression is contemplated in various modifications. A variety of heat exchange (cooling) techniques may be arranged either within the compression chamber or the compression process may be embedded in the heat exchanger to cool down the working fluid (for example, CO₂).

### REFERENCE TO RELATED APPLICATION(S)

This Utility Patent Application is based on and claims priority to Provisional Patent Application No. 63/050,407 filed on 10 Jul. 2020, which hereby is incorporated by reference in its entirety.

### FIELD

The present disclosure addresses a system and a method for fluid compression, and in particular, to nearly or highly isothermal fluid compression.

The present disclosure is further directed to a system and method for attaining an isothermal compression process where a compression process may be carried out within a heat exchanger, although the heat transfer may be also incorporated within a compression chamber.

The present disclosure is also directed to a system and method applied to a positive displacement compression process for use in a variety of applications, including, but not limited to, gas processing, air conditioning, refrigeration systems, etc.

In particular, the present disclosure addresses a positive displacement compression mechanism enhanced with a set of cooling techniques which may reduce a working fluid temperature during a compression process enhance a compression efficiency in the system.

The present disclosure is also directed to a system and method for a highly efficient isothermal compression where heat removal is integrated with a compression process. In this system, a heat removal mechanism may be added to a compression mechanism which itself may be achieved through a variety of techniques (including, but not limited to, solid or liquid pistons). The heat removal mechanism may incorporate the compression processes inside the heat exchanger, or alternatively, the heat transfer may be embedded within a compression chamber, with the heat transfer being of various configurations (as an example, in the form of small diameter tubes/channels which are particularly suited for the process, with a coolant flowing inside the tubes/channels) to remove the heat generated by the working fluid during the compression process.

In addition, the present invention is directed to a system and method for highly efficient isothermal compression where compression is integrated within a heat exchanger (for example, a tube/fin or a micro-channel heat exchanger). The compression mechanism in this embodiment may be accomplished through solid pistons or liquid pistons via hydraulic pumps.

Furthermore, the present disclosure addresses a compression system implemented with a single-piston or multiple-piston designs, single- or double-action pistons, as well as multiple-action pistons, where a working fluid is compressed independent of the direction the incompressible liquid (for example, oil) is pumped. The compression process may occur in four steps, including a) a suction step, b) an isentropic compression until the working fluid reaches temperatures slightly higher than that of the cooling fluid to enable heat transfer, c) an isothermal compression step, where heat is removed from the working fluid by the external cooling fluid as the working fluid continues to be compressed, and d) a discharge step, where the working fluid is discharged from the compression unit under essentially constant pressure and possibly residual heat transfer. The heat transfer mechanisms may be applied into the present system jointly or separately to steps (a)-(d) individually, or in any combination.

The present disclosure is also directed to a highly efficient isothermic compression, where the compression process may take place alternately and repetitively in two (or more) sets of compression units filled partially with an incompressible fluid (for example, oil), and a compressible working fluid (for example, CO₂). The incompressible fluid acts as a piston compressing the working fluid arranged in compression channels, where, when the oil initially fills the first set of compression channels, the second set of compression channels (acting at this time as a suction chamber) is subject to a vacuum condition which enables the suction of the working fluid into the second set of compression channels. The working fluid is drawn into the suction chamber through a suction port formed in a top header fluidly connected with the second set of compression channels. A hydraulic pump drives the oil from the first set of compression channels (filled with oil) into the second set of channels (filled with CO₂) to compress the working fluid to a higher pressure. As a result, the second set of compression channels switches from the suction chamber mode to a compression chamber mode, and the first set of compression channels switches from a compression chamber mode to a suction chamber mode with the working fluid drawn in the first set of channels simultaneously. When the working fluid reaches a required pressure level or threshold, a discharge port on the top header opens and discharges the working fluid. After completion of the discharge process, the pump at the bottom of the system switches the flow direction of incompressible fluid such as oil and drives the oil from the second set of compression channels to the first set of compression channels to compress the working fluid in the first set of the compression channels.

In addition, the present disclosure addresses a compression process which is cyclically repeated in an alternate manner by reversing a direction of the oil pumping to fill either a first set or a second set of the compression channels. In the exemplary embodiment, the compression channels may be incorporated inside a heat exchanger. As the working fluid is being compressed in either set of the compression channels (e.g., first or second sets of the compression channels), a coolant medium, such as air, water, or any other suitable fluid, is circulated external to the compression channels operating as a heat sink to absorb the heat generated by the compression process. The external cooling brings the compression of working fluid close to being isothermal and consequently improves the compression efficiency.

The present disclosure is also directed to a system and method for isothermal compression where a plurality of compression channels have an internal structure which may include fins that provide an increased surface area, or a turbulence generator for the working fluid to increase the cooling effect caused by an external coolant washing over and moving between the compression channels. Such internal structure within the compression channels is contemplated in various configurations including needle-shaped, mesh, foam, wavy shapes, etc. The internal structure may be rigid or a shape conforming to the internal working fluid flow.

In addition, the present disclosure is directed to a system and method for isothermal compression, where the compression channels may be configured with external heat transfer enhancing structures, which may be attached externally to the walls of the compression channels either mechanically or chemically. The configuration of the external heat transferring enhancing structure may vary depending on the application and may include the configurations such as spine, wavy, circular, and others. The purpose of the external heat transfer enhancing structure is to increase the heat transfer area for the external coolant, and to generate turbulence to enhance the heat transfer.

Further, the present disclosure is directed to a compression system with highly efficient isothermal (or near-isothermal) performance where the compression channel configuration may include straight channels as well as fractal-shaped channels which may be of a divergent style or convergent style. In the divergent style channels, oil is pumped from the bottom to compress the working fluid, while the working fluid flow path diverges during the compression process. The convergent style channels may be used also to address the density increase along the compression process. In both, the divergent and convergent fractal configurations, the diverging and converging is arranged along the direction of compression.

The present disclosure also addresses a compression system, where the isothermal compressor is embedded with the instrumentation to measure its performance and efficiency, and a CO₂ loop coupled to the isothermal compressor to collect the discharged high-pressure CO₂ from the isothermal compressor and reduce its pressure and temperature to the suction level and to refill the isothermal compressor with a lower pressure/temperature CO₂. An oil loop is coupled to the isothermal compressor to control the oil entrance/retraction into the (or out of) the isothermal compressor to compress the CO₂ in the compression channels.

### BACKGROUND

A compressor is a mechanical device that increases the pressure of a gas (or any other fluid) by reducing the gas volume. There are numerous principles which underly the operation of compressors, and thus, a variety of different types of compressors are available, including positive displacement compressors and dynamic compressing systems. The positive displacement compressor is a system which compresses the air by displacement of a mechanical linkage reducing the volume (the reduction in volume due to a piston is in thermodynamics considered as positive displacement of the piston). A positive displacement compressor thus operates by drawing a discrete volume of gas from its inlet, then forcing that gas to exit via a compressor's outlet. The increase in the pressure of the gas is due, at least in part, to the compressor pumping it at a mass flow rate, which cannot pass through the outlet at the lower pressure and density of the inlet. Positive displacement compressors are available in numerous designs including reciprocating (diaphragm, double-acting, signal-acting), and rotary type compressors (in the form of lobe, screw, liquid ring, scroll, vane). The dynamic compressor type is available in the form of a centrifugal and axial compressor modification.

The thermodynamics of gas compression teaches that a compressor can be idealized as internally reversible and adiabatic, thus an isentropic device, meaning the change in entropy is zero. By defining the compression cycle as isentropic, an ideal efficiency for the process can be calculated and the ideal compressor performance can be compared to the actual performance of the machine. By comparing the internally reversible processes for compressing an ideal gas from pressure P1 to pressure P2, the results show that isentropic compression requires the most work, and isothermal compression requires the least amount of work.

There are two models of the compressor functioning including the adiabatic model, which assumes that no energy (heat) is transferred to or from the gas during the compression, and all supplied work is added to the internal energy of the gas, resulting in increases of temperature and pressure, however the compression does not follow a simple pressure to volume ratio. Adiabatic compression or expansion more closely models real life or actual systems when a compressor has high insulation capabilities, a large gas volume, or a short time schedule (i.e., a high power level). In actual practice, there is always a certain amount of heat flow out of the compressed gas. Thus, making a perfect adiabatic compressor would require perfect heat insulation of all parts of the machine which is not attainable.

Another model of the compressor system functionality is an isothermal model which assumes the compressed gas remains at a constant temperature throughout the compression or expansion process. In this process, the internal energy is removed from the system as heat at the same rate that it is added by the mechanical work of compression. Isothermal compression or expansion more closely models real-life considerations when the compressor has a large heat exchange surface, a small gas volume, or a long-time scale (i.e., a small power level).

Compressors that utilize inner stage cooling between compression stages come closest to achieving perfect isothermal compression and are state-of-the-art. However, with practical devices, perfect isothermal compression is not attainable. For example, unless an infinite number of compression stages is provided with corresponding inter-coolers, a perfect isothermal compression is not achievable.

Since the isothermal compression is significantly more energy efficient than the adiabatic compression, numerous approaches for providing and attaining near isothermal compression have been attempted.

For example, Tang Ren, et al. suggests a “Novel Isothermal Compression Method for Energy Conservation in Fluid Power Systems” described in “Entropy”, 2020, 22, pg. 1015. The reference addresses an isothermal compression method to lower the energy consumption of compressors where a porous medium is introduced to an isothermal piston. The porous medium is located beneath a conventional piston and radially emerges into the liquid during compression. The compression heat is absorbed by the porous medium and finally conducted to the liquid at the chamber bottom. The heat transfer, as stated by Tang Ren, et al., can be enhanced due to the large surface area of the porous medium. Due to the fact that the liquid has a large heat capacity, the liquid temperature can be maintained substantially constant through the external circulation. This creates near-isothermal compression, which minimizes energy loss in the form of heat, which cannot be recovered. There will be mass loss of the air due to dissolution and leakage. Therefore, the dissolution and leakage amount of gas are compensated for in this approach.

Another approach for near isothermal compression and expansion is described in “Near Isothermal Compression” by Ryan S. Wood, et al., published in “Turbo Machinery International”, January-February 2016, Volume 57, Number 1. The authors state that the isothermal compression is impossible to achieve, but, by removing heat stage-by-stage from the compressor by water cooling the stator vanes, and by adding heat fins to increase air-side surface area, the work required to compress air can be reduced.

Another attempt to attain the near isothermal machine is described in the PCT Application WO2016/189289, where a machine for compressing or expanding gas comprises a piston operating downwards in a compression stroke with respect to an inclined or vertical cylinder and upwards with respect to the cylinder in an expansion stroke. The piston has a heat absorbing and releasing structure attached to its bottom face. There is a gap between the piston and the base of the cylinder when the gas volume in the cylinder is at its minimum. The gap contains a hydraulic fluid, which absorbs heat from the heat absorbing and releasing structure. A heat transfer surface containing fluid circulating to and from an external source maintains the hydraulic fluid at a constant temperature. In one arrangement, the heat absorbing and releasing structure comprises thin sheets of aluminum attached orthogonally to the bottom face of the piston.

Although numerous attempts have been made to attain an isothermal or near isothermal compression process, none of the prior art isothermal compression systems uses a concept of incorporating the compression process inside a heat exchanger, and there is still a need for a positive displacement compression mechanism and a set of cooling approaches aimed at reducing the working fluid temperature during the compression process to enhance compression efficiency.

### SUMMARY

It is therefore an object of the present disclosure to present a positive displacement compression mechanism embedded with cooling technology aimed to reduce the working fluid temperature during the compression process to a level close to the temperature of the coolant to enhance compression efficiency.

It is a further object of the present disclosure to address systems and methods for fluid compression where highly- or near-isothermal compression is attained by conducting the compression process within a heat exchanger.

It is still an object of the present disclosure to reflect a positive displacement compression process which is highly efficient and environmentally safe for use in a variety of applications, such as, for example, gas processing, air conditioning, refrigeration systems, etc.

In one aspect, examples of the present disclosure address a system for isothermal compression, which comprises one or more compression units, each containing an incompressible liquid medium and a working fluid medium in contact with the incompressible liquid medium. A compressing mechanism is operatively coupled to the incompressible liquid medium to controllably displace its level within the compression unit to result in compression of the working fluid medium to a predetermined pressure value. The compression of the working fluid medium results in the generation of compression heat.

To attain an isothermal compression, the subject system is equipped with a heat exchange sub-system operatively integrated with the compression unit(s). In a preferred embodiment, the heat exchanger sub-system may incorporate the compression channel(s) internally. The heat exchange sub-system may contain a cooling medium circulating in a thermal coupling with the compression unit(s) to absorb the heat generated as the result of the compression process resulting in cooling of the working fluid medium in the compression unit(s) to a level as close as possible to the temperature of the coolant to attain the isothermal compression.

A controller sub-system is operatively coupled to the compression mechanism to control the level of the incompressible liquid medium in the compression unit(s). The speed of raising the level of the incompressible liquid medium may be controlled so that to attain either a longer time of the heat transfer (for achieving a better heat transfer) or a shorter time of the heat transfer (for achieving a larger working fluid capacity). The controller sub-system also is operatively coupled to discharge port(s) and suction port(s) to control discharge and entrance of the working fluid medium passing from and to the compression unit(s), respectively.

In one of the preferred embodiments, the compression unit is configured with a plurality of the channel structures arranged in a fractal configuration, having either a diverging or a converging configuration. The diverging and converging direction of the channel structures corresponds to the direction of the compression process. The channel structures in the fractal configuration have variable channel dimensions.

The present system further comprises a heat transfer enhancing structure embedded with channel structure(s). The heat transfer enhancing structure may be configured as an internal heat transfer enhancing structure disposed in an internal lumen of a compression unit, or an external heat transfer enhancing structure disposed externally and in contact with the compression channel wall of the channel structure of the compression unit (s). A combination of the internal and external heat transfer enhancing structures is also contemplated in the subject system.

In one of various example implementations, the subject system may be configured with a first and second plurality of the channel structures arranged in a substantially parallel fashion.

In this embodiment, the controller sub-system operates the first and second pluralities of the channel structures in a compression mode alternately, where (1) the first plurality of the channel structures operates intermittently, under control of the controller sub-system, in a first compression mode and a first suction mode, and (2) the second plurality of channel structures operate intermittently, under control of the controller sub-system, in a second compression mode and a second suction mode. The first compression mode is aligned in time with the second suction mode, and the first suction mode is aligned in time with the second compression mode.

The subject system further includes a reversible pumping sub-system operatively coupled to the controller sub-system where, in the second suction mode, the incompressible liquid medium fills the first plurality of the channel structures, and the working fluid medium enters into said second plurality of the channel structures. The first suction mode and second compression mode of operation are attained subsequent to the reversible pumping sub-system directing (under control of the controller sub-system) the incompressible liquid medium from the first plurality of the channel structures into the second plurality of the channel structures, resulting in compression of the working fluid medium in the second plurality of the channel structures, while the working fluid medium enters into and fills the first plurality of the compression channel structures through a first suction port in a first upper header.

The controller sub-system is adapted to convert the first suction mode and the second compression mode of operation into the first compression mode and the second suction mode of operation, respectively, by reversing the pumping sub-system to direct the incompressible liquid medium from the second plurality of the channel structures into the first plurality of the channel structures through the first and second lower headers, respectively.

In another aspect, the present disclosure addresses a method for isothermal compression which includes the steps of:

establishing and operating a compression sub-system which is configured with:

(a) a compression unit housing an incompressible liquid medium and a working fluid medium in contact with the incompressible liquid medium,

(b) a heat exchanging sub-system incorporating the compression unit therewithin, where the heat exchanging sub-system contains a cooling medium circulating with a thermal contact with the compression unit, and

(c) a controller sub-system operatively coupled to the compression sub-system and the heat exchanging sub-system;

raising, in a controllable manner, a level of the incompressible liquid (fluid) medium within the compression unit(s) to compress the working fluid medium to a predetermined pressure value with a controlled speed of changing the level of the incompressible liquid medium;

discharging the working fluid medium from the compression unit(s) when a predetermined pressure level has been attained;

retracting the incompressible liquid medium from the compression unit(s) while entering the working fluid medium into the compression unit(s); and

circulating the cooling medium inside the heat exchanger in a thermal coupling with the compression unit(s) to absorb the heat generated as the result of the compression of the working fluid medium, thus cooling the working fluid medium in the compression unit(s) to attain an isothermal compression.

In the present method, the channel structures may be configured with various configurations, for example, selected from a group of micro-channels, tubes, and combinations thereof, where the channel structures are disposed either in a substantially parallel relationship or in a fractal configuration in a diverging or a converging fashion.

The heat transfer in the present method is enhanced by embedding an internal heat transfer enhancing structure in the internal lumen of the channel structures or by embedding an external heat transfer enhancing structure in contact with the channel wall of the channel structure of the compression unit(s). The combined arrangement with the internal and the external heat transfer enhancing structures is also contemplated in the present method.

In one example of the subject method, the channel structures may be arranged in a first and a second plurality of substantially parallel channel structures conducting the compression in the first and second plurality of parallel channel structures in an alternating order. The first plurality of the channel structures are operated intermittently in a first compression mode and a first suction mode. The second plurality of the channel structures are operated intermittently in a second compression mode and a second suction mode. The first compression mode is aligned in time with the second suction mode, as well as the first suction mode is aligned in time with the second compression mode.

The subject method also includes the step of fluidly coupling a first and second lower header to a lower end and an upper end of each of the channel structures, respectively. A reversible pumping sub-system is operatively coupled to the first and second lower headers. In the second suction mode, the reversible pumping sub-system is operated to fill the first plurality of the channel structures with the incompressible liquid medium.

The incompressible liquid medium flows from the first plurality of the channel structures into the second plurality of the channel structures, resulting in compression of the working fluid medium in the second plurality of the channel structures, wherein the working fluid medium enters and fills the first plurality of channel structures through a first suction port at the first upper header during the first suction mode of operation. The first suction mode of operation and the second compression mode of operation are converted into the first compression mode of operation and the second suction mode of operation, respectively, by reversing the reversible pumping sub-system to direct the incompressible liquid medium from the second plurality of the channel structures into the first plurality of the channel structures through the first and second lower headers. By alternately actuating the first and second discharge ports at the first and second upper headers, respectively, the working fluid medium may exit through the first or second discharge ports from the first or second plurality of the channel structures when the working fluid medium reaches a predetermined pressure level in the first or second pluralities of channel structures.

These and other objects and advantages of the subject systems and methods addressed in the present disclosure will be apparent in view of the Drawings and description of the preferred embodiments presented herein.

### BRIEF DESCRIPTION OF THE DRAWINGS

FIG. 1 is a schematic representation of the subject compression system supporting an isothermal compression process;

FIG. 2A shows schematically one of the embodiments of the subject compression system implemented with two sets of compression channels for alternate compression;

FIG. 2B shows schematically the subject compression process carried out in the system of FIG. 2A;

FIG. 3 is an embodiment of the present system where the compression channel is configured with an internal heat transfer enhancing structure;

FIG. 4 is another embodiment of the present compression system with the compression channel modified with an external heat transfer enhancing structure;

FIGS. 5A and 5B depict compression channels having a fractal configuration in the diverged (FIG. 5A), and the converged (FIG. 5B) modifications embedded with external and/or internal heat transfer enhancing structures;

FIG. 6 is a diagram reflecting the cooling requirement for the isothermal compression showing that more cooling is needed at higher pressure levels;

FIG. 7 is a diagram reflecting the benefits of using the fractal configuration (shown in FIGS. 5A-5B) showing that the fractal configuration is capable of maintaining the discharge temperature of the working fluid (CO₂) as close as possible to the temperature of the heat removal fluid (coolant) in comparison with the temperature increase of the working fluid when the fractal configuration is not used;

FIG. 8 depicts a schematic of heat removal embedded within a compression chamber;

FIG. 9 depicts a schematic of a hydraulic compression where a two-hydraulic-piston configuration is used to eliminate the use of solid pistons;

FIG. 10 depicts a compression process arranged within a heat exchanger;

FIG. 11 depicts a concept of the heat exchanger tilted at up to 45° to ensure the maximum volumetric efficiency;

FIG. 12 depicts a profile view of the heat exchanger with a larger header at the bottom to maximize utilization of the heat exchanger; and

FIG. 13 depicts an example of the subject isothermal compressor system coupled with the CO₂ loop and the oil loop.

### DETAILED DESCRIPTION

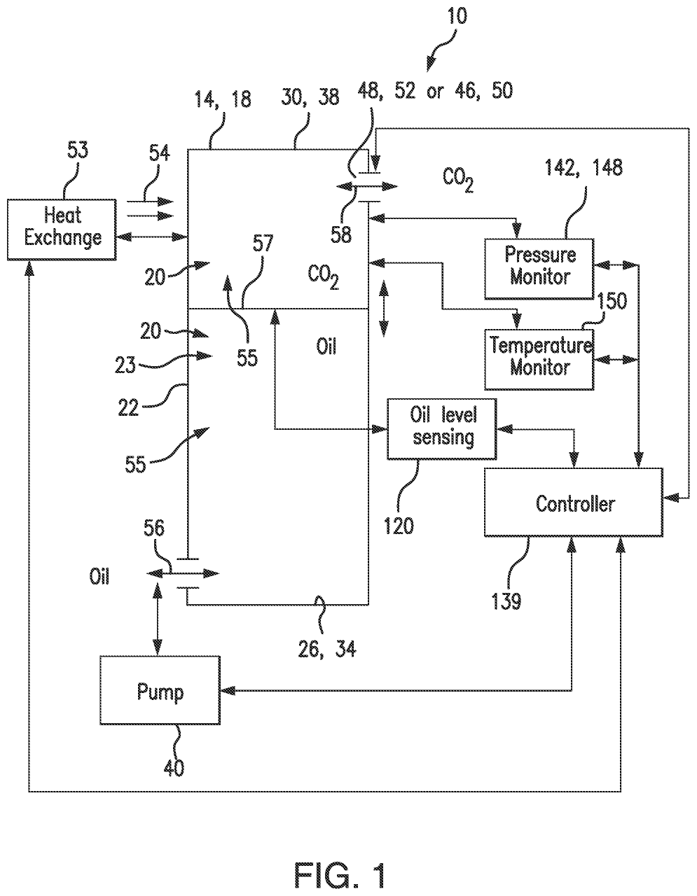

Referring to FIGS. 1-5B and 8-13, the subject compression system 10 is configured to support a substantially isothermal compression process. The present compression system 10 operates to compress working fluid(s), preferably a gas (such as, for example, refrigerants) using one or more compression units, such as, for example, liquid pistons, arranged inside compression channels (such as, for example, micro-channels) and/or tubes (as, for example, used inside tube-and-fin heat exchangers).

The exemplary subject compressor system 10 will be further described in conjunction with operational principles presented in FIGS. 1 and/or 2A-2B for conciseness and clarity, but it is apparent to those skilled in the art that the subject concept applies to both solid and/or liquid pistons, as well as single or multiple pistons in the compressor process as to be described herein.

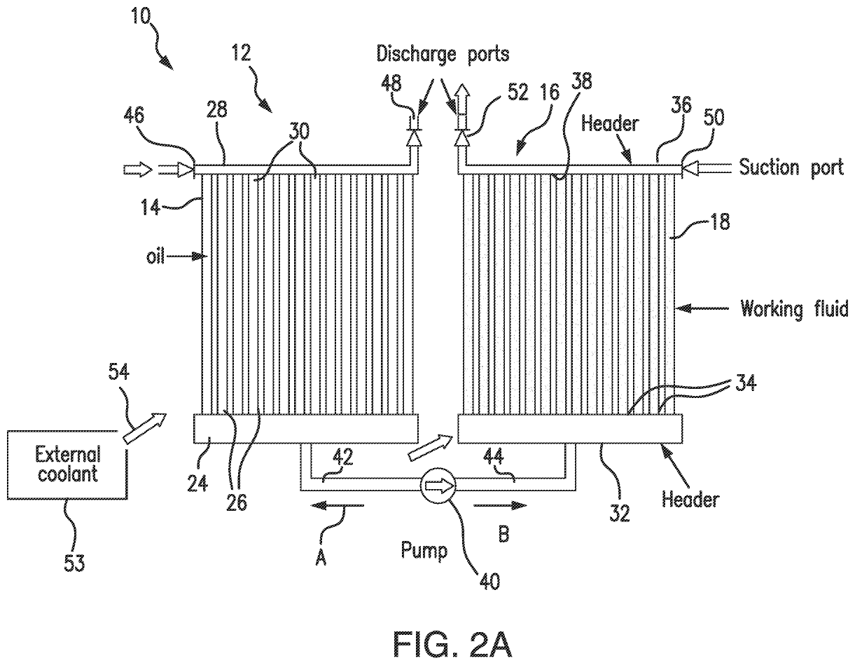

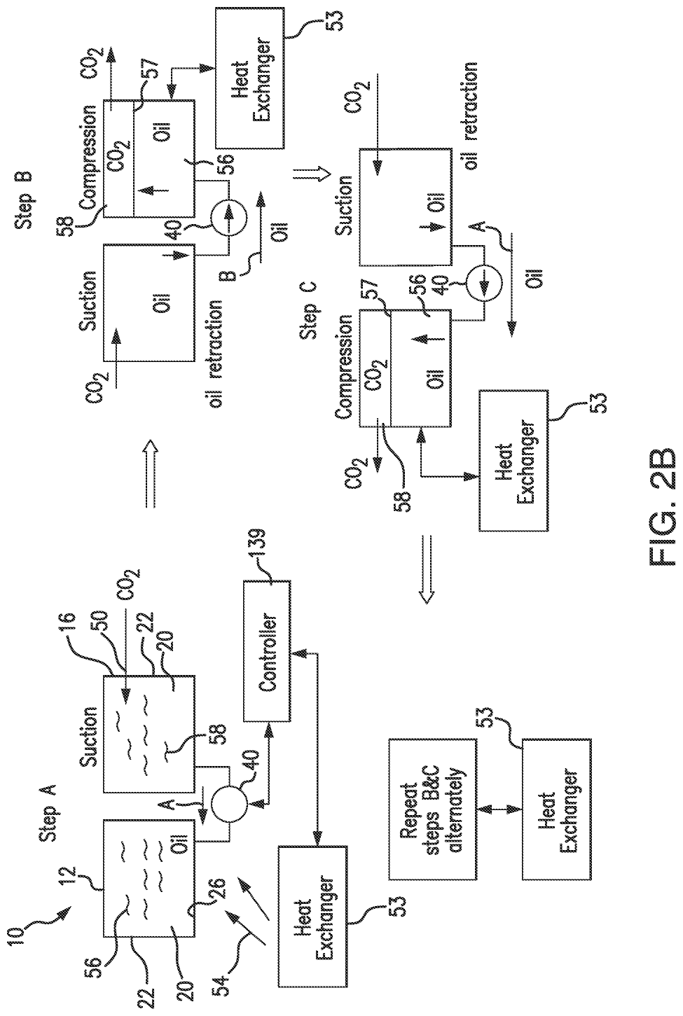

As depicted in FIGS. 2A-2B, the subject system 10 may include a first set 12 of compression channels 14 and a second set 16 of the compression channels 18. Each of the compression channels 14 and 18, as detailed in FIG. 1, may, for clarity, be configured as a cylindrical structure having an internal longitudinal cavity 20 enveloped and defined by a channel wall 22. The cavity 20 in the compression channel 14 and 18 is filled with a fluid medium 55 which includes an incompressible liquid (such as, for example, oil) 56 and a working fluid 58. Each compression channel 14, 18 is filled partially with the incompressible liquid 56 acting as a liquid piston 23 compressing the compressible working fluid 58 inside the internal cavity 20 of the channels 14 and 18.

Although various configurations and relative dispositions between the compression channels 14, 18 are contemplated in the subject system, in one of the embodiments such as depicted in FIGS. 1 and 2A-2B, the compression channels 14 in the first set 12 of compression channels 14 are similar to compression channels 18 in the second set 16 of compression channels 18 and may be disposed in parallel with one another. The compression channels 14 are disposed in a fluid communication with a first bottom header 24 at the bottom edges 26 of the channels 14 and with the first top header 28 at the top edges 30 of the compression channels 14.

Similarly, the compression channels 18 are disposed in a fluid communication with the second bottom header 32 at the bottom edges 34 of the compression channels 18 and with the second top header 36 at the upper edges 38 at the second set 16 of the compression channels 18. The bottom headers 24 and 32 are connected in fluid coupling with a reversible pump 40 through the passages 42 and 44, respectively.

The top header 28 is configured with a suction port 46 and a discharge port 48, while the top header 36 is configured with a suction port 50 and discharge port 52.

Heat exchange sub-system 53 is operatively integrated with the compression system 10. Although the heat exchange may be incorporated in the compression (piston) cylinder, in a preferred embodiment of the present system, the heat exchanger 53 includes the compression process incorporated in the heat exchanger 53. The heat exchange sub-system 53 may be provided in a variety of modifications. As an example only, without limiting the scope of the subject system and process, the heat exchange sub-system 53 may support a circulating external coolant 54 supplied to the first and second sets 12, 16 of the compression channels 14, 18 for a heat exchange with the walls 22 of the channels 14 and 18, and ultimately for reducing the temperature of the working fluid inside the compression channels 14, 18 to maintain the temperature of the working fluid as close as possible to the temperature of the coolant 54 to attain an isothermal compression process, as will be described in detail in further paragraphs.

The fluid medium 55 inside the compression channel 14,18 defines an incompressible liquid 56 (such as, for example, oil, or any other appropriate compression liquid cyclically supplied to the channels 14 or 18) and a working fluid 58 which are supplied in the compression channels 14, 18 in a generally intermittent manner The working fluid 58 is supplied into the channels 14 and 18 (at a predetermined pressure and temperature) in a predetermined order through the suction ports 46 and 50, respectively, and is discharged, as required by the subject process, through the discharge ports 48 and 52, respectively, at a predetermined pressure level, as will be detailed infra.

The oil (or any other incompressible fluid or liquid) 56 is preferably insoluble and immiscible with the working fluid 58, and acts as a liquid piston 23 for compressing the working fluid 58. In the exemplary embodiment, the compression mechanism which is carried out by the oil (i.e., the liquid piston 23) in each compression channel 14, 18, relies on buoyancy separation of the incompressible liquid 56 with respect to the working fluid 58 which may in many circumstances be compressible, for example, a carbon dioxide (CO₂). Therefore, a large density difference, low miscibility and a low viscosity are the important characteristics for the liquid piston fluid 55. The subject system may use Paraffin mineral oil which has been shown to be one of the best liquids in terms of insolubility with CO₂. Counter-intuitively, water also has good insolubility with respect to CO₂ as it is strongly polar which can be enhanced with the dissolution of salts into the water.

In one particular example, shown in FIGS. 2A-2B, the compression process takes place alternatively in two sets of compression channels 14 and 18. However, the embodiments using only one set of compression channels, or more than two sets of compression channels, also represent viable options and are contemplated within the scope of the present system.

In the exemplary embodiment depicted in FIGS. 2A-2B (in conjunction with the schematic representation of the subject system (also referred to herein as a compression system, or a subject compression system) 10, as depicted in FIG. 1, in Step A, the pump 40 runs the oil 56 in the direction A (shown in FIG. 2A) towards the bottom edges 26 of the compressor channels 14. As the incompressible or substantially incompressible liquid (fluid) fills (in step A) the first set 12 of compression channels 14, the second set 16 of the compression channels 18 acts as a suction chamber, as it is subject to a vacuum condition which enables the suction of the working fluid 58 into the channels 18. The working fluid 58 is drawn into the suction chamber (channel 18) through the suction port 50 located at the side of the second top header 36.

In the subsequent Step B (as shown in FIG. 2B), the hydraulic pump 40 located at the bottom of the system 10 reverses its flow direction A (as in Step A) to the direction B (shown in FIG. 2A), and drives the incompressible fluid (or oil) 56 from the channels 14 into the second set 16 of the compression channels 18 through the passages 42, 44 (in FIG. 2A, direction B) connected to the bottom headers 24, 32.

Upon reversal of the pumping direction in Step B, the second set 16 of channels 18 switches from operating in the suction chamber mode to a compression chamber mode, while the first set 12 of channels 14 switches from the operation in a compression chamber mode to a suction chamber mode where the working fluid 58 is drawn in the compression channels 14.

In Step B, the incompressible fluid (or oil) 56 fills the channels 18, and, as the level of the oil 56 is displaced toward the top edges 30 of the channels 18, the oil 56 compresses the working fluid 58 in the channels 18 to a higher pressure level. In addition, in Step B, as the incompressible fluid (for example, oil) 56 is retracted from the compression channels 14, the working fluid 58 fills the channels 14 through the suction port 46 at the top header 28.

As the working fluid 58 is being compressed in either set 12, 16 of the channels 14, 18, the external coolant 54, such as, for example, air, water, or any other fluids, is circulated in thermal contact with the compression channels 14, 18 acting as a heat sink to absorb the heat generated by the compression process. The external cooling process causes the compression of the working fluid 58 to approach an isothermal condition, which is a highly efficient mode of compression operation, and consequently improves the compression efficiency of the subject system as compared to any traditional compression technology.

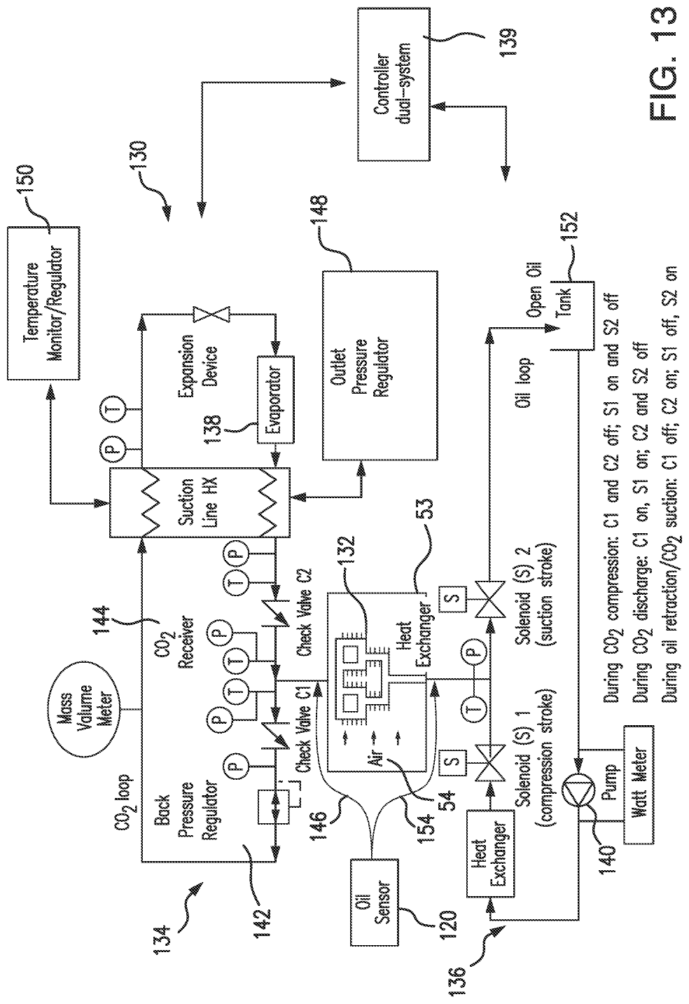

When the working fluid 58 reaches a required pressure level (for example, in the channels 18), the discharge port 52 formed in the top header 36 opens (under control of the controller sub-system 139) and discharges the working fluid 58 into a CO₂ receiver 144 (shown in FIG. 13).

After completion of the discharge process from the compression channels 18 in Step B, the pump 40 controllably reverses its direction (as in Step C, shown in FIG. 2B) and pumps the oil 56 in the direction A (FIG. 2A) from the set 16 of channels 18 to the set 12 of the channels 14 to compress the working fluid 58 in the first set 12 of the compression channels 14, repeating the previously described procedure of Step B. Steps B and C can continue in a repetitive, alternate manner as long as the isothermal compression is needed.

The process described in previous paragraphs is a double-acting compression process, in which the working fluid 58 is compressed independent of which set of the compression channels 14 or 18 are used and in which direction the incompressible fluid 56 is pumped. The operational capabilities can be applied to single-acting compression processes as well as those with multiple (more than two) compression processes.

The operation of the subject system is coordinated and controlled by the controller sub-system 139 included in the present system 10 (as best shown in FIGS. 1 and 13) which is operatively coupled to (a) the pump 40 to control its reversible operation, to (b) the discharge ports 48, 52, as well as to (c) the suction ports 46,50, to actuate/de-actuate these ports to attain timely discharge and suction operations when required by the compression process. The controller sub-system 139 coordinates the operational routines (or operational sequencing) in the subject compression system 10 based on the readings of one or a number of sensors, and associated instrumentation, such as including, for example, the oil level sensor 120, pressure monitors/regulators 142, 148, temperature monitor(s) 150, as shown in FIGS. 1 and 13, and detailed infra herein. The controller sub-system 139 also is operatively coupled to the heat exchanger 53 (best shown in FIGS. 1, 2A, 2B, and 13) to control its operation to support the isothermal compression process ensured in the subject system 10.

In this embodiment, the controller sub-system operates the first and second pluralities of the channel structures in a compression mode alternately, where (1) the first plurality of the channel structures operates intermittently, under control of the controller sub-system, in a first compression mode and a first suction mode, and (2) the second plurality of channel structures operate intermittently, under control of the controller sub-system, in a second compression mode and a second suction mode. The first compression mode is aligned in time with the second suction mode, and the first suction mode is aligned in time with the second compression mode.

The subject system further includes a reversible pumping sub-system operatively coupled to the controller sub-system where, in the second suction mode, the incompressible liquid medium fills the first plurality of the channel structures, and the working fluid medium enters into said second plurality of the channel structures. The first suction mode and second compression mode of operation are attained subsequent to the reversible pumping sub-system directing (under control of the controller sub-system) the incompressible liquid medium from the first plurality of the channel structures into the second plurality of the channel structures, resulting in compression of the working fluid medium in the second plurality of the channel structures, while the working fluid medium enters into and fills the first plurality of the compression channel structures through a first suction port in a first upper header.

The subject compression process may be categorized generally as occurring in four steps. These steps of the subject process include: (a) a suction step; (b) an isentropic compression until the working fluid reaches a temperature that is slightly higher than that of the cooling fluid to enable heat transfer; (c) an isothermal compression step, where heat is removed from the working fluid by the external cooling fluid as the working fluid continues to be compressed; and (d) a discharge step, where the working fluid is discharged from the compression device under essentially constant pressure (and possibly residual heat transfer). The heat transfer techniques presented infra may be applied jointly or separately to either one or all of the steps, or any combination of the steps supra.

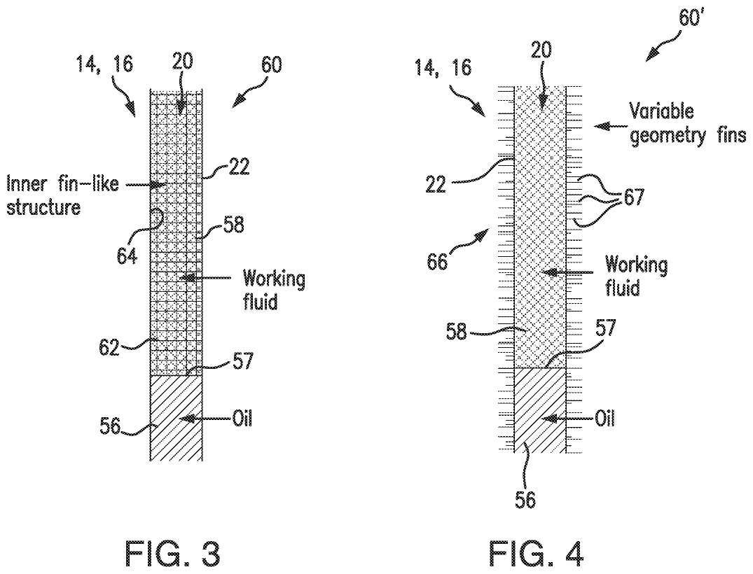

FIG. 3 depicts an alternative embodiment of the subject system, where a heat transfer enhancement mechanism 60 is applied to the compression channels 14, 18. To increase the cooling effect by the external fluid, the channel 14, 18 may be configured with an internal structure 62, which may include internal fin-like elements 64 that form an increased surface area and/or turbulence generator. The actual configuration of the internal structure 62 may vary. For example, alternatively or in addition to the fin-like element 64, the internal structure 62 may be formed with needles, mesh, foam, wavy shaped elements, etc. The internal structure 62 may be rigid or shape conforming to the working fluid 58 flowing inside the compression channels 14, 18. The internal structure 62 does not obstruct the compression process and preferably induces a minimal pressure drop. The material of the internal structure 62 may include metals, plastics and/or other materials that provide a sufficient heat transfer enhancement.

In an alternative embodiment, shown in FIG. 4, the heat transfer enhancement mechanism 60′ may be configured in the form of an external structure 66, affixed to the outer surface of the channel walls 22 of the compression channels 14, 18. In this example, the compression channels 14, 18 may have affixed with externally disposed fin elements 67, or other heat transfer enhancing configurations. The external fin elements 67 may be externally attached to the walls 22 of the compression channels 14, 18 either mechanically or chemically. The external fin elements 67 may be spine-shaped, or have wavy, circular, or other various configurations. The purpose of the external structure 66 is to increase the heat transfer area for the external coolant medium (or coolant) 54 and to further generate a fluid turbulence to enhance the heat transfer. As the heat flux along the channels 14, 18 of the compression system varies, the arrangement of the external fin elements 67 (or other elements) may be variable according to the cooling demand. Variable parameters may include the density of fin elements, the material of the fin elements, the length of the fin elements, as well as the shape or contour of the fin elements.

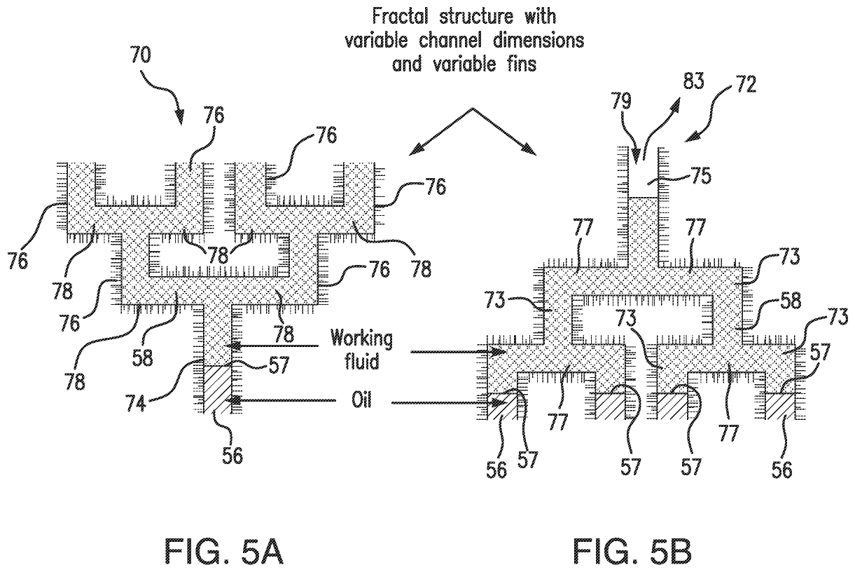

Referring to FIGS. 5A-5B, in addition, or alternatively to the configuration of the compression channels 14, 18, fractal-shaped channels (also referred to herein as fractal-shaped configurations, or fractal channel designs) 70 and 72 can be contemplated in the subject system.

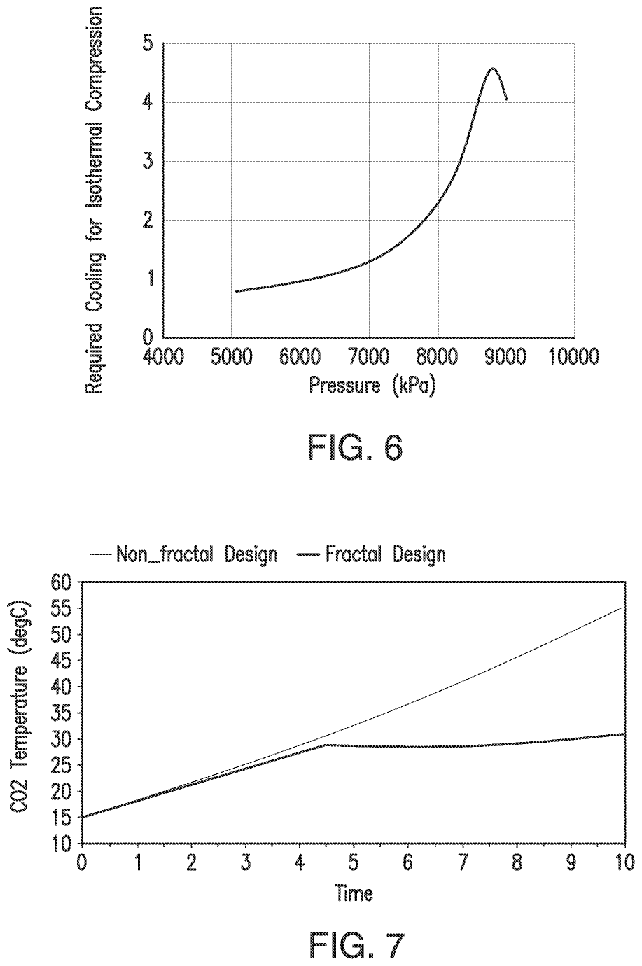

FIGS. 5A and 5B depict two sets of fractal-shaped channel designs, including the divergent style 70 (FIG. 5A), and the convergent style 72 (FIG. 5B). The fractal-shaped configuration may augment the heat transfer area, and thus may provide a higher cooling capacity when necessary. The cooling requirement of the isothermal compression increases during the compression process (as shown in FIG. 6), so more cooling is needed at higher pressure levels. Each fractal configuration 70, 72 splits a main channel into multiple primary sub-channels fluid which are in communication with each other via secondary sub-channels extending in angular (crossing) relationship to the primary sub-channels. Although, as shown in FIGS. 5A-5B, the main and primary sub-channels are disposed in a vertical orientation, while the secondary sub-channels are disposed in a horizontal orientation, other orientations deviating from the vertical and horizontal, are contemplated in the subject system, including a tilted or inclined orientation of the fractal-shaped channels 70, 72 defining a non-perpendicular angle between the primary and secondary sub-channels, which is applicable to the subject system's design. The diverging and converging of the channels in the fractal-shaped configurations 70, 72 are in correspondence to the compression direction. In either modification, the heat transfer area per sub-channel volume increases.

In the divergent fractal-shaped configuration (FIG. 5A), the incompressible fluid (or oil) 56 is pumped from the bottom of the main channel 74 to compress the working fluid 58 which is positioned atop the incompressible fluid (or oil) 56. The working fluid flow path diverges during the compression process into primary sub-channels 76 via the secondary (crossing) sub-channels 78. As shown in the FIG. 5A, each split generates two (or more) horizontal (or crossing) secondary sub-channels 78 which may be bent 90 (or other angle) degrees relative to the primary sub-channels 76. Those splits and bends may not necessarily be 90 degrees, since any angle is contemplated as long as it facilitates the flow of the working fluid 58 and does not induce a large pressure drop.

The converging fractal-shaped configuration 72, shown in FIG. 5B, has the network of lower primary sub-channels 73 converging in a single upper channel 75. The primary sub-channels 73 are interconnected by secondary (crossing) sub-channels 77 extending in an angular relationship to the upper channel 75. The incompressible fluid (for example, oil) 56 enters the converging fractal-shaped configuration 72 through a plurality of the lower level primary sub-channels 73, while the working fluid enters the compression unit into the converging fractal-shaped configuration 72 through a suction port 79 at the top (or any other location) of the upper channel 75. The oil level 57 raises (as the oil fills the primary sub-channels 73), and the working fluid 58 is compressed. Once a predetermined pressure of the working fluid 58 is attained, the compressed working fluid is discharged from the upper channel 75 via a discharge port 83.

The main channel and sub-channels may have different sizes, for example, higher level channels may have larger diameters than the diameters of the lower level channels. Depending on the thermal and hydraulic properties of the working fluid, the convergent style channels in the fractal-shaped configuration 72 (FIG. 5B) may be preferred to address the density increase along the compression process. For both fractal channel configurations 70, 72, the internal and external heat transfer enhancement methods, shown in FIGS. 3-4, may be applied singularly or in combination.

FIG. 7 reflects isothermal capabilities of the fractal design in the compression process. As shown, the fractal design maintains the discharge temperature of the working fluid (i.e., CO₂) as close to as the temperature of the coolant, for example, below 31° C., while in alternative embodiments (not using the fractal configuration), the temperature of the working fluid, (i.e., CO₂) increases, for example, from 15° C. to 55° C., as shown in the diagram.

It has been found that in conventional compressors, piston displacement is small (typically, measured in single-digit cubic centimeters), while the revolutions per minute are high (usually in the thousands). In the subject preferred design, the opposite is the case, i.e., the displacement volume is measured in the thousands of cubic centimeters, while the strokes per minute may be in the range of single digits. Thus, the subject system is slower acting and heat transfer processes are slowed down accordingly. Therefore, any and all methods traditionally used for enhancing heat transfer under laminar flow conditions are applicable to the subject system.

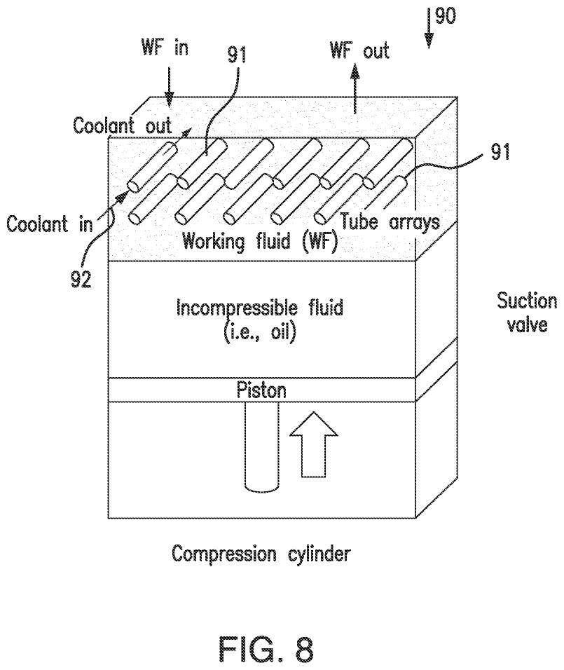

FIGS. 8-10 reflect various cooling techniques applicable to the present compression system. In certain embodiments, the subject system may implement heat removal embedded within a compression chamber. FIG. 8 depicts an example embodiment 90 where a heat exchanger, in this case a tube array 91 with small diameter tubes, is integrated into a compression chamber (compression cylinder). In the example embodiment 90, the small diameter tubes preferably have a diameter of less than 0.5 mm

This embodiment is preferred for use where compactness of the compression unit is an important consideration. Larger dimensions and alternative heat exchanger designs may be used for other applications. In the embodiment of FIG. 8, a coolant 92 flows inside the flow channels defined by the tubes in the tube array 91. The coolant 92 absorbs heat generated by the working fluid during the compression process that results in the isothermal compression process.

The heat absorbed by the coolant 92 may be rejected externally to the ambient air or recovered by other components. The coolant 92 may be any suitable liquid, including a two-phase medium, or gaseous heat transfer medium, for example, air, water, or refrigerant. In certain embodiments, the heat rejection means may be of alternative designs, including, for example, tube bundles with or without fins, microchannel tubes with or without fins, liquid spray, or heat pipes, among other techniques.

The compression mechanism is achieved through a variety of methods, for example, with the use of traditional solid pistons, which may cause a relatively large dead volume or extended perimeter length needed to be sealed, or a liquid piston. The liquid piston contains an incompressible, or nearly incompressible, liquid that is insoluble, immiscible, does not interact with the working fluid, and does not undergo any chemical reaction with the working fluid. In certain embodiments, the liquid piston may be driven and controlled by a hydraulic pump and switching valves. In such an embodiment, a traditional mechanical piston may not be needed.

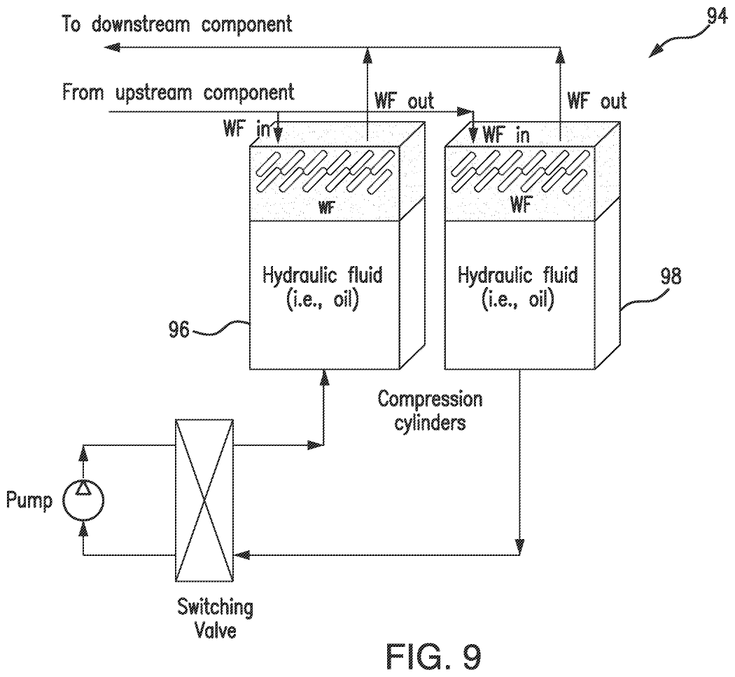

FIG. 9 depicts an example system embodiment 94, wherein a two-hydraulic-piston design is used to eliminate the use of solid pistons. In this example, one liquid piston 96 compresses the working fluid, while the second liquid piston 98 conducts the suction stroke.

One or more switching valves (which may be one or more separate valves or valves integrated into one or more units), are used to reverse the flow direction of the hydraulic fluid. In certain embodiments, the use of a bi-directional hydraulic pump is used to replace the switching valves, shown in FIG. 9.

The hydraulic mechanism in the example system embodiment 94 may have many different possible example implementations. For example, the hydraulic mechanism may be equivalent to single or multiple piston designs, single and double-acting pistons, or pistons with multiple actions.

In certain preferred embodiments, expansion mechanisms are included that recover work from the expansion process of the vapor compression system and thus reduce the required work input to the compression process.

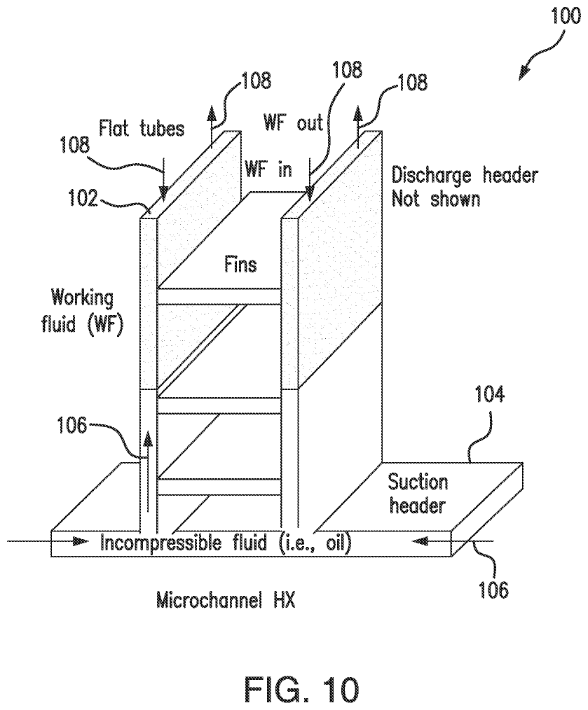

In some preferred embodiments, the subject system implements compression process embedded within heat exchangers where a compression process is integrated within heat rejection means, as for an example is shown in FIG. 10. In this example system embodiment 100, the compression process takes place inside a heat rejection mechanism, for example, in a tube-fin or a micro-channel heat exchanger, among other types of heat exchangers. In the example depicted in FIG. 10, the heat exchanger is oriented in a manner such that the fluid channels, or tubes 102, are oriented at an angle to the horizontal direction, and an incompressible liquid 106 is admitted from a suction header 104, which in this embodiment is the bottom header. In the exemplary system 100, shown in FIG. 10, the incompressible liquid 106 is pushed or driven to compress the working fluid 108 in the tubes 102 while the compression generated heat is removed. Alternatively, discharge and suction valves may be used which may be located in proximity to the top discharge header.

The compression technology shown in FIG. 10, may be configured with a solid piston or a liquid piston via hydraulic pumps. For example, a discharge valve may be positioned on the top of each of the individual microchannel tubes 102 to discharge the compressed gas (“WF out”) into the discharge half of the top header, and a suction valve to admit the suction vapor (“WF in”) into the microchannel as liquid recedes in the suction stroke. Thus, the top header may be split into two halves lengthwise to accommodate the discharge gas (“WF out”) and the suction gas (“WF in”). Alternative designs for the top header of the subject system 100, may for example, include one or more intermediate suction port(s) provided to convert a single-stage compressor into a two-stage or multi-stage compressor.

For both embodiments, i.e., (a) the heat removal within a compression chamber and (b) the compression within heat exchangers, either the solid piston or the incompressible fluid may be arranged such that the working fluid is compressed from top to bottom or other direction(s).

In certain embodiments of either subject cooling technique, a liquid/gas separator may be added at the discharge port so that any residual liquid, which will act as a piston, can be separated from the working fluid, and the separated liquid can be routed back to the compressor.

The subject isothermal compressors in either of the example implementations depicted in FIGS. 1-5B and 8-13, may be staged either in parallel or in series.

It is noted that traditional compressors achieve a required working fluid flow rate by having small displacement volume and high revolutions or strokes per minute. This concept may apply preferentially to the heat-exchanger-inside-a-cylinder version. The compression-inside-a-heat-exchanger version may have a relatively larger displacement volume and a relatively low rate of strokes (or revolutions) per minute.

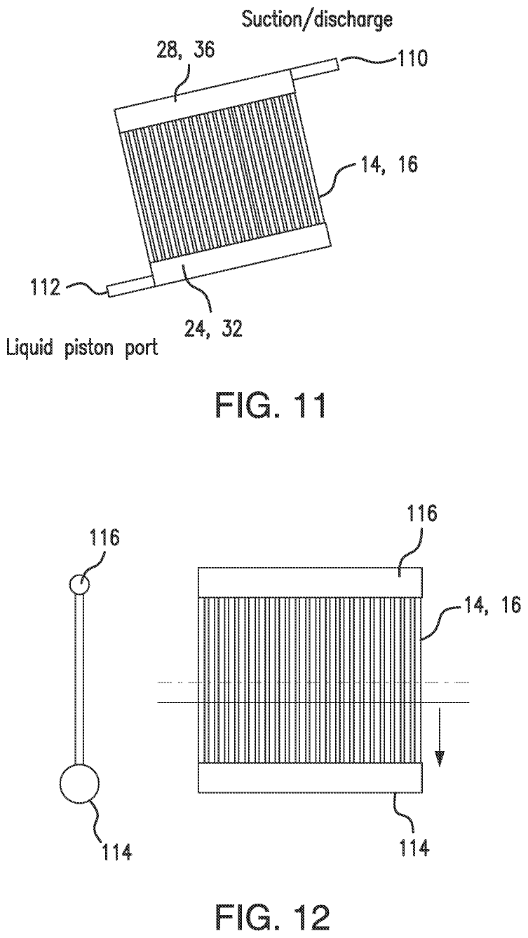

In the subject heat exchanger—compressor design, the heat exchanger preferably may be tilted at the angle up to 45°, as shown in FIG. 11, to ensure the maximum volumetric efficiency. This approach is beneficial in minimizing the possible trapping of working fluid such as carbon dioxide (CO₂) in the corners and ensure the maximum refrigerant displacement. The highest point 110 of the tilted compressor (at the top header 28, 36) serves as a valved suction/discharge port. The lowest point 112 (at the bottom header 24, 32) serves as a liquid piston port. In order to provide economically advantageous fabrication costs, the system can be manufactured with straight parallel connections between the compression channels instead of angled ones.

An alternative embodiment shown in FIG. 12 has a larger size of the bottom header 114 when taken with respect to the upper header 116. For a symmetrical heat exchanger/compressor with equal-sized headers at the top and bottom, the desired compression volume would occur somewhere in the middle of the heat exchanger and would use only half of the available heat transfer area. Therefore, to increase a usable heat transfer area, a larger header 114 at the bottom is desirable. This embodiment is beneficial in maximizing the utilization of the heat exchanger/compressor. This optimization provides for the desired compression volume being reached at a point where the working fluid surface area exposure is maximized.

Another design alternative may be contemplated by applying a taper to the top header 116 to minimize the internal volume of the heat exchanger-compressor to minimize the cooling needed for the compressed fluid in the top header 116.

Referring to FIG. 13, the exemplary embodiment of the subject isothermal compression system 130 comprises the isothermal compressor (also referred to herein as isocomp) 132 which is schematically depicted as being incorporated inside the Heat Exchanger 53 and which may be implemented in any of the exemplary embodiments 10, 60, 60′ 70, 72, 90, 94, and 100, shown in FIGS. 1-5B and 8-12, respectively, plus all instrumentation to measure its performance and efficiency of the system, a CO₂ loop 134 (which collects the discharged high-pressure CO₂ from the isocomp 132, reduces its pressure (and the temperature) to the suction level and re-fills the isocomp 132 with lower pressure CO₂), and an oil loop 136 which pumps oil, e.g., Polyalkylene Glycol (PAG) to act as a liquid piston to compress the CO₂. The system 130 allows for a single-acting isothermal compression and produces cooling to the ambient temperature by the evaporator 138 in the CO₂ loop 136.

The subject system 130 operates under control of the Controller sub-system 139 which is operatively coupled to all components of the system (as also shown in FIG. 1) to control operational stages and parameters of the compression-cooling process supported by the system (depicted in FIGS. 1-5B and 8-12) based on the readings of the various instrumentation used in the subject system, shown in FIG. 1.

As shown in FIGS. 1 and 13, the subject system 10, 130 includes a liquid level sensing sub-system 120 which operates to sense the oil level to obtain switching criteria and supply the corresponding readings or data to the controller sub-system 139, which in response controls the operation of the pump 40 for determining cycling criteria. In addition, the liquid level sensor 120 in conjunction with the controller 139, can operate to control the speed at the raise of the oil level to either slow down the oil level raising to allow for a longer time for the heat transfer (to achieve a better heat transfer) or to speed up the oil level raising to reduce the heat transfer time (in order to achieve a larger working fluid capacity).

The sub-system 120 may be chosen from at least three applicable liquid-level sensing categories including (a) optical, (b) capacitance and (c) magnetic for obtaining a switching criteria for each stroke.

A capacitance sensor measures the capacitance between its two plates or surfaces. The dielectric constant of the oil vs CO₂ would change the capacitance. This may be used as a switching criterion to control the operation of the pump 40. An optical sensor with a light source and a sensor may be used in two ways, including (a) through the fluid, or (b) at a single point. Sending the light through the fluid needs 2 sight glasses with a light source at one end and a photoresistor at the other end. The measured light intensity may be used as the switching criteria. The difference between readings can be enhanced by adding a dye to the incompressible fluid or oil.

The single-point measurement uses a light source and a photoresistor as well, but they are coupled to a glass tip. The presence of liquid on the glass would change the refraction angle of the light and change the light intensity the photoresistor reads. The glass has a higher probability of oil retention on the glass, and therefore can provide a sufficient sensing technique.

A magnetic sensor is based on buoyancy. This technique involves the use of a magnet on a float in the pipe (compression channel) and an external Hall Effect sensor to determine the position of the float. As the liquid rises, it would displace the magnet which passes through the sensor. The readings of the sensor reflect the detected liquid level, and a switch controlling the operation of the pump 40, may be triggered accordingly to switch the direction of the oil pumping or to stop pumping. In the system shown in FIG. 13, the oil level sensor 120 is represented by an upper oil sensor 146 and a lower oil sensor 154, the function of which is described infra.

The process in the system 130 is initiated with CO₂ filling the isocomp 132 at a suction pressure, for example, 5 MPa. The pump 140 and solenoid valve Si will then be turned ON to enter the oil in the isocomp 132 and to fill the isocomp 132 to the level (sensed by the oil level sensor 120) when CO₂ is compressed by the oil until the discharge pressure, for example, 10 MPa, controlled by the Back Pressure regulator 142/Controller Sub-System 139, is reached.

The high-pressure CO₂ will subsequently exit the isocomp 132 through the now opened check valve C1 towards the CO₂ receiver 144 where CO₂ is stored at a discharge pressure. During the CO₂ discharge routine, the solenoid S1 and the pump 140, under the control of the Controller Sub-System 139, remain ON to push CO₂ out of the isocomp 132 until the upper oil sensor 146 detects the oil droplet. Subsequently, the pump 140, the check valve C1, as well as the solenoid S1, will be closed by the Controller Sub-System 139 simultaneously.

The CO₂ from the CO₂ receiver 144, while driven by its high pressure, passes through the Suction Line HX, which may include an Outlet Pressure Regulator 148 and the Temperature Monitor 150, where the pressure P and temperature T, respectively, of CO₂ is adjusted to the suction conditions. Subsequently, the CO₂ (as the appropriately reduced pressure and temperature) will flow towards the isocomp 132 through the now opened check valve C2 to fill the isocomp 132. This action retracts the oil from the isocomp 132. The retracted oil will pass through the now opened solenoid valve S2 towards the oil tank 152 until the lower oil sensor 154 detects no presence of oil. With the isocomp 132 again filled with CO₂ at the suction pressure, the second round of compression resumes.

Although examples of the present system and method have been described in connection with specific forms and embodiments thereof, it will be appreciated that various modifications other than those discussed above may be resorted to without departing from the spirit or scope of the system/method as defined in the appended claims. For example, functionally equivalent elements may be substituted for those specifically shown and described, certain features may be used independently of other features, and in certain cases, particular locations of elements, steps, or processes may be reversed or interposed, all without departing from the spirit or scope of the invention as defined in the appended claims.

What is claimed is:

1. A system for isothermal compression, comprising:
a heat exchange sub-system,
at least one compression unit incorporated inside said heat exchange sub-system, said at least one compression unit containing an incompressible liquid medium and a working fluid medium in contact with said incompressible liquid medium,
a compression mechanism operatively coupled to said incompressible liquid medium to displace a level thereof within said at least one compression unit to result in compression of said working fluid medium to a predetermined pressure value, wherein said compression of said working fluid medium generates heat,
at least one discharge port actuated to discharge said working fluid medium from said at least one compression unit when said predetermined pressure value has been attained,
at least one suction port actuated to enter said working fluid medium in said at least one compression unit,
wherein said heat exchange sub-system contains a cooling medium circulating in a thermal coupling with at least one said compression unit to absorb the heat generated as the result of the compression and thus cooling the working fluid medium in said at least one compression unit to attain an isothermal compression, and
a controller sub-system operatively coupled to said compression mechanism to control said level of said incompressible liquid medium in said at least one compression unit, to said at least one discharge port and said at least one suction port to control discharge and entrance of said working fluid medium passing from, and to said at least one compression unit, respectively.

2. The system of claim 1, wherein said at least one compression unit is configured with at least one channel structure having an upper end, a lower end, and a channel wall extending between said upper and lower ends, said channel wall defining an internal lumen containing said incompressible liquid medium and said working fluid medium, and
wherein said at least one channel structure includes at least one structure selected from a group comprising a single channel, a plurality of channels, micro-channels, tubes, and combination thereof, disposed in a predetermined relationship to one another, said predetermined relationship including a parallel disposition of said channel structures, an angled disposition of said channel structures, a crossing disposition of said channel structures, and combinations thereof.

3. The system of claim 2, wherein said at least one compression unit is configured with a plurality of said channel structures arranged in a fractal configuration, wherein said fractal configuration includes a main channel, a plurality of primary sub-channels, and a plurality of secondary sub-channels extending angularly to and interconnecting said plurality of primary sub-channels with said main channel in a diverging fractal configuration or a converging fractal configuration.

4. The system of claim 3, wherein said plurality of the channel structures in said fractal configuration thereof have variable channel dimensions.

5. The system of claim 3, wherein in said plurality of the channel structures in said diverging fractal configuration, said main channel is a main lower channel branching into said primary sub-channels located above said main lower channel, wherein said incompressible liquid medium enters said compression unit in said main lower channel, and wherein said working fluid medium fills at least said plurality of primary sub-channels and said secondary sub-channels,
wherein said plurality of channel structures in said converging fractal configuration includes a plurality of primary sub-channels arranged in a multi-tier configuration with lower primary sub-channels located at a lower level and converging in upper primary sub-channels located above said lower level primary sub-channels, and converging into said main channel located at a top level, wherein said incompressible liquid medium enters said at least one compression unit into said lower primary sub-channels, and wherein said working fluid medium fills at least said main channel located at the top level and said primary sub-channels, and
wherein in said diverging and converging fractal configurations, respectively, said primary sub-channels and said main channels extend in a direction corresponding to a direction of the compression.

6. The system of claim 3, further comprising a heat transfer enhancing structure embedded with said at least one channel structure, said heat transfer enhancing structure being selected from a group of:
(a) an internal heat transfer enhancing structure disposed in said internal lumen of said at least one compression unit, and (b) an external heat transfer enhancing structure disposed externally and in contact with said channel wall of said at least one channel structure of said at least one compression unit, and combinations thereof

7. The system of claim 6, wherein said internal heat transfer enhancing structure is configured with elements formed from metals, plastics, and combinations thereof selected from a group comprising foam, fins, needles, mesh, waved elements, rigid elements, shape conforming elements, and combinations thereof, and
wherein said external heat transfer enhancing structure is configured with elements selected from a group of fin elements having various densities, shapes, materials, and dimensions.

8. The system of claim 2, further comprising:
a first plurality of said channel structures arranged in a substantially parallel fashion, and
a second plurality of said channel structures arranged in a substantially parallel fashion,
wherein said compression mechanism is operatively coupled to said first and second plurality of the channel structures, and
wherein said controller sub-system operates said first and second pluralities of the channel structures in a compression mode alternately.

9. The system of claim 8, wherein said first plurality of the channel structures operate intermittently, under control of said controller sub-system, in a first compression mode and a first suction mode,
wherein said second plurality of said channel structures operate intermittently, under control of said controller sub-system, in a second compression mode and a second suction mode,
wherein said first compression mode is aligned in time with said second suction mode, and
wherein said first suction mode is aligned in time with said second compression mode.

10. The system of claim 9, further including:
a first lower header and a first upper header fluidly coupled to said lower end and upper ends, respectively, of each of said channel structures in said first plurality thereof,
a second lower header and a second upper header fluidly coupled to said lower end and upper end, respectively, of each of said channel structures in said second plurality thereof,
a reversible pumping sub-system operatively coupled to said controller sub-system and disposed in a fluid communication with said first and second lower headers,
wherein said at least one suction port includes a first suction port and a second suction port configured at said first and second upper headers, respectively,
wherein said at least one discharge port includes a first discharge port and a second discharge port configured at said first and second upper headers, respectively,
wherein in said second suction mode, said incompressible liquid medium fills said first plurality of the channel structures, and said working fluid medium enters said second suction port at said second upper header into said second plurality of the channel structures, and
wherein said first suction mode of operation and said second compression mode of operation are attained subsequent to said reversible pumping sub-system directing, under control of said controller sub-system, said incompressible liquid medium from said first plurality of the channel structures into said second plurality of the channel structures, resulting in compression of said working fluid medium in said second plurality of the channel structures, and wherein said working fluid medium enters into and fills said first plurality of the channel structures throughout the first suction port at the first upper header.

11. The system of claim 10, wherein said controller sub-system is adapted to convert said first suction mode and said second compression modes of operation into said first compression mode and said second suction mode of operation, respectively, by reversing said pumping sub-system to direct said incompressible liquid medium from said second plurality of the channel structures into said first plurality of the channel structures through said first and second lower headers, respectively.

12. The system of claim 11, wherein said controller sub-system as adapted to actuate said first and second discharge ports at said first and second upper headers, alternately upon the working fluid medium reaches a predetermined pressure level in said first or second pluralities of the channel structures, respectively, and said working fluid medium escapes through said first or second discharge ports, respectively, from said first or second pluralities of the channel structures, and
wherein said controller sub-system is adapted to reverse the operation of said pumping sub-system subsequent to the discharge of the working fluid medium.

13. The system of claim 10, wherein said first and second lower headers have a larger dimension than the first and second upper headers.

14. The system of claim 1, wherein said at least one compression unit is tilted at an angle of up to 45°.

15. A method for isothermal compression, comprising:
(a) operating a compression sub-system containing:
at least one compression unit housing an incompressible liquid medium and a working fluid medium in contact with said incompressible liquid medium,
a heat exchanging sub-system incorporating said at least one compression unit therewithin, said heat exchanging sub-system containing a cooling medium, and
a controller sub-system operatively coupled to said compressing sub-system and said heat exchanging sub-system;
(b) raising a level of said incompressible liquid medium within said at least one compression unit with a controlled speed of raising the level of the incompressible liquid medium to compress said working fluid medium to a predetermined pressure level, wherein the compression of said working fluid medium generates heat;
(c) discharging said working fluid medium from said at least one compression unit when said predetermined pressure value has been attained;
(d) retracting said incompressible liquid medium from said at least one compression unit while entering said working fluid medium into said at least one compression unit; and
(e) circulating said cooling medium in a thermal coupling with said at least one compression unit to absorb the heat generated as a result of the compression of said working fluid medium, thus cooling the working fluid medium in said at least one compression unit to attain an isothermal compression.

16. The method of claim 15, further comprising:
in said step (a), configuring said at least one compression unit with at least one channel structure having an upper end, a lower end, and a channel wall, extending between said upper and lower ends, and defining an internal lumen internally of said channel wall, said internal lumen containing said incompressible liquid medium and said working fluid medium, and
configuring said at least one channel structure with at least one structure selected from a group of micro-channels, tubes, and combinations thereof, and disposing a plurality of said channel structures in a substantially parallel relationship or in a fractal configuration in a diverging or a converging fashion.

17. The method of claim 16, further comprising:
in said step (a), integrating a heat transfer enhancing structure with said at least one channel structure, said at least one channel structure being selected from a group consisting of an internal heat transfer enhancing structure embedded in said internal lumen of said at least one channel structure of said at least one compression unit, an external heat transfer enhancing structure integrated in contact with said channel wall of said at least one channel structure of said at least one compression unit, and a combination thereof.

18. The method of claim 16, further comprising:
arranging said channel structures in a first plurality and a second plurality of substantially parallel channel structures, and
conducting the compression in said first and second pluralities of the parallel channel structures in an alternating order.

19. The method of claim 18, further comprising:
operating said first plurality of the channel structures intermittently in a first compression mode at a first suction mode,
operating said second plurality of the channel structures intermittently in a second compression mode and a second suction mode, and
aligning in time said first compression mode with said second suction mode, and said first suction mode with said second compression mode.

20. The method of claim 19, further comprising:
in said step (a), fluidly coupling a first lower header and a first upper header to a lower end and an upper end, respectively, of each of said channel structures in said first plurality thereof,
fluidly coupling a second lower header and a second upper header to a lower end and an upper end, respectively, of each of said channel structures in said second plurality thereof,
operatively coupling a reversible pumping sub-system to said first and second lower headers, respectively,
configuring a first discharge port and a second discharge port at said first and second upper headers, respectively, and
configuring a first suction port and a second suction port at said first and second upper headers, respectively;
in said second suction mode of operation, operating said reversible pumping sub-system to fill said first plurality of the channel structures with said incompressible liquid medium, and controlling said working fluid medium to enter said second suction port at said second upper header into said second plurality of the channel structures;
attaining said first suction and second compressing modes of operation by controlling said reversible pumping sub-system to direct the incompressible liquid medium from said first plurality of the channel structures into said second plurality of the channel structures, resulting in compression of said working fluid medium in said second plurality of the channel structures, wherein said working fluid medium enters into and fills said first plurality of channel structures throughout the first suction port at the first upper header during said first suction mode of operation;
converting said first suction and said second compression modes of operation into the first compression and the second suction modes of operation, respectively, by reversing said reversible pumping sub-system to direct said incompressible liquid medium from said second plurality of the channel structures into said first plurality of the channel structures through said first and second lower headers;
alternately actuating said first and second discharge ports at said first and second upper headers, respectively, upon the working fluid medium reaches said predetermined pressure level in said first or second pluralities of the channel structures, respectively, to discharge said working fluid medium through said first or second discharge ports, respectively, from said first or second pluralities of the channel structures; and
reversing the operation of said reversible pumping sub-system in a predetermined order to repeat said steps (b), (c), (d), and (e).
